(19) United States
(12) Patent Application Publication
(10) Pub. No.: US 2008/0040886 A1
(43) Pub. Date: Feb. 21, 2008

(54) Bearing and hinge mechanism

(75) Inventors: Robert Arnold, Little Torch Key, FL (US); Dhananjay Bhatt, Laguna Hills, CA (US); Nicholas Welche, Irvine, CA (US); Andy Lee, Santa Ana, CA (US)

Correspondence Address: MICHAUD-DUFFY GROUP LLP, 306 INDUSTRIAL PARK ROAD, SUITE 206, MIDDLETOWN, CT, 06457, US

(73) Assignee: Roller Bearing Company of America, Inc., Oxford, CT (US)

(21) Appl. No.: 11/698,535

(22) Filed: Jan. 26, 2007

Related U.S. Application Data
(60) Provisional application No. 60/763,114, filed on Jan. 26, 2006.

(51) Int. Cl. F16C 33/10

(52) U.S. Cl. 16/275; 384/322

(57) ABSTRACT

A spherical plain bearing has an outer ring having a concave first bearing surface and an inner ring having a convex second bearing surface slidably disposed to the first bearing surface. The inner ring member also has a third bearing surface for engaging a pin to be mounted in the bearing. At least one bearing surface has a lubrication groove, and one of the outer ring and the inner ring is made from 440 stainless steel while the other is made from a precipitation-hardened martensitic stainless steel. Alternatively, the outer ring and the inner ring may be made from steel and a copper-beryllium alloy. In yet another alternative, the bearing need not have a lubrication groove, but may have a lubrication liner on the third bearing surface. A dropped hinge mechanism for a flap on a fixed wing aircraft has a hinge that includes such a bearing.

### CROSS-REFERENCE TO RELATED APPLICATION

This application claims the benefit of U.S. provisional application number No. 60/763,114, filed Jan. 26, 2006, the contents of which are incorporated herein by reference in their entirety.

### BACKGROUND

Spherical plain bearings normally include an inner ring member (also known as a ball) and outer ring member (also known as a race) wherein the outer ring member has a spherically concave interior surface that defines a cavity therein, and the inner ring member is disposed in the cavity and has a spherically convex surface that is complementary to, and is dimensioned to match, the interior concave surface of the outer ring member. The concave and convex surfaces are the sliding surfaces or bearing surfaces.

It is known to provide a lubricant between the sliding surfaces of a spherical plain bearing, and to provide a lubrication channel in one of the sliding surfaces. The lubrication channel is a recess from the sliding surface within which a reserve of lubricant can be disposed. The recess is open to the other sliding surface, which can be contacted by the lubricant. As the second surface slides, it carries lubricant between the sliding surfaces to lubricate the bearing.

In prior art spherical plain bearings used in the design of flight control systems, the inner ball and the outer race have been made from the same kind of steel. Such steel-on-steel bearings are grooved for lubrication. However, steel-on-steel bearings are only useful in structural joints where a minimum amount of flexing of the structure is required to avoid the transmission of stresses into surrounding structure. Steel-on-steel bearings will weld together (adhesive galling) when placed in an environment with high angles of oscillation and super-imposed vibration. They provide no redundancy (failsafe) quality to the selected materials. Due to the high hardness and high modulus of elasticity of the steel ball; any design feature such as a key slot in the face of the ball or anti-rotation pin (shear pin) through the ball will crack the ball when loads are applied. This characteristic is well documented in the MIL spec standards for small bore diameter bearings (MS 14101-3 and -4 sizes).

Based on the foregoing, it is the general object of this invention to provide a bearing that improves upon, or overcomes the problems and drawbacks of prior art bearings.

### SUMMARY OF THE INVENTION

The present invention resides in one aspect in a spherical plain bearing comprises an outer ring member having a spherically concave first bearing surface and an inner ring member having a spherically convex second bearing surface in sliding disposition in the first bearing surface. The inner ring member also has a third bearing surface for engaging a pin to be mounted in the bearing. At least one bearing surface comprises a lubrication groove, and one of the outer ring member and the inner ring member comprises 440 stainless steel and the other comprises a precipitation-hardened martensitic stainless steel.

The present invention resides in another aspect in a spherical plain bearing comprises an outer ring member having a spherically concave first bearing surface and an inner ring member having a spherically convex second bearing surface in sliding disposition to the first bearing surface. The inner ring member also has a third bearing surface for engaging a pin to be mounted to the bearing. At least one bearing surface comprises a lubrication groove, and one of the outer ring member and the inner ring member comprises steel and the other comprises a copper-beryllium alloy.

In still another aspect, this invention provides a bearing that comprises an outer ring member having a spherically concave first bearing surface and an inner ring member having a spherically convex second bearing surface in sliding disposition to the first bearing surface. The inner ring member has a third bearing surface for engaging a pin to be mounted to the bearing. There is a lubrication liner on the third bearing surface and on one of the first bearing surface and the second bearing surface.

In yet another aspect, this invention provides a dropped hinge mechanism for a flap on a fixed wing aircraft, wherein the mechanism comprises a hinge and the hinge includes a bearing as described herein.

### BRIEF DESCRIPTION OF THE DRAWINGS

FIG. 1 is a cross-sectional view of one embodiment of a bearing as described herein;

FIG. 2 is a cross-sectional view of a second embodiment of a bearing as described herein; and

FIG. 3 is a schematic elevation view of a dropped hinge wing mechanism that comprises a bearing as described herein.

### DETAILED DESCRIPTION OF THE INVENTION

This invention provides new designs for spherical plain bearings that are useful in flight control systems, and allows for improved re-design of a hinge based on the spherical plain bearings. Bearings as described herein find utility in various places, including in the hinge of a dropped hinge mechanism for dropping the flap on a fixed wing aircraft, such as an Airbus A400M. In some embodiments, the bearings are inherently failsafe because there is a difference between the materials of the inner ring and outer ring so that the two rings will not adhesively gall together. For example, one of the rings may have an iron base material while the other is made from a copper-based material.

This invention provides greased and non-greased (i.e., self-lubricated) embodiments of spherical plain bearings. When incorporated into a hinge, a hinge pin is mounted inside an inner ball member and primary rotation occurs between the hinge pin and bore diameter of the ball. The outer ring member is mounted in the hinge. Rotation at the spherical surfaces of the bearing is secondary and ‘failsafe’ to the primary bore surface. For the greased option, the lubrication path is to be provided by passages through the hinge pin. For the self-lubricated design option, a lubricating liner material is applied at the bore of the ball and the side faces of the ball in addition to the spherical interface of the bearing.

In the greased embodiment, one of the ball and the race material may be made from copper-beryllium and the other is made from steel. Copper-beryllium (BeCu) is a high load bearing material which will provide inherent failsafe qualities to the hinge design. The differential in base materials (steel versus BeCu) result, in a tribological pair with excellent wear properties. The bearing will not weld due to adhesive galling and can accommodate a low level of grease starvation.

In the self-lubricated bearing option, both the race and the ball may optionally be made from 440C hardened CRES (corrosion-resistant) steel material. Alternatively, titanium may be used, e.g., as the ball material, to reduce the weight of the bearing.

Spherical plain bearings as described herein optionally allow portions of a hinge to directly engage the bearing ball faces.

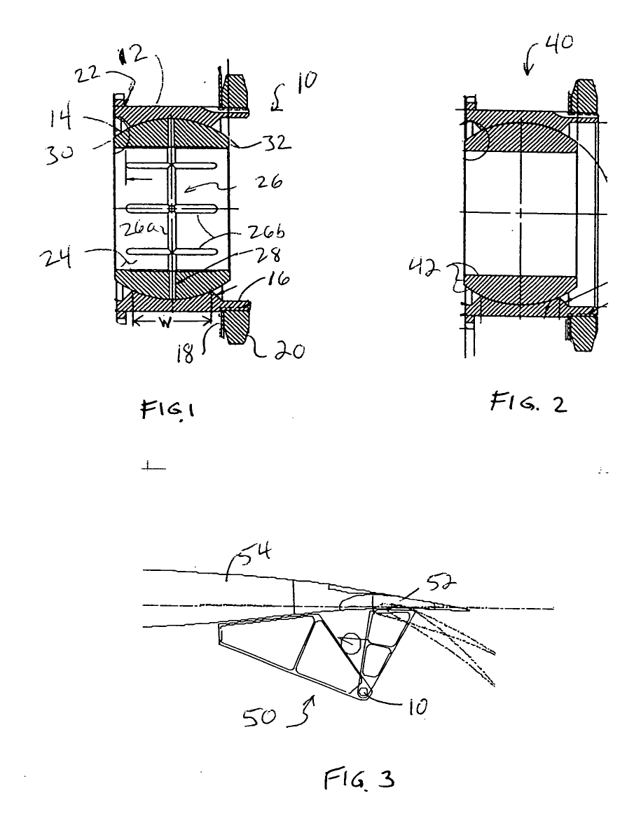

A cross-sectional view of a first spherical plain bearing 10 is shown in FIG. 1. Bearing 10 is a greased bearing in which a differential is provided between the base materials of the outer ring and the inner ring. Bearing 10 comprises an annular outer ring 12 and an annular inner ring 14 that have spherically convex and concave sliding surfaces, respectively. Each of outer ring 12 and inner ring 14 has a central axis therethrough. Inner ring 14 is shown in FIG. 1 with its central axis coinciding with the central axis of outer ring 12. Outer ring 12 is formed around inner ring 14 in a swaging process in which an axial flange 16 is formed on the outer ring 12. Optionally, axial flange 16 may be externally threaded. A lock washer 18 and lock nut 20 are seen mounted on flange 16 and may be used to mount bearing 10 in a hinge socket. At the opposite axial end of outer ring 12 there is a second end flange 22. The concave sliding surface of outer ring 12 has an effective race width W in an axial direction. W is smaller than the width of the sliding surface of inner ring 14 in the axial direction, at the ends of the concave sliding surface, so that outer ring 12 forms a conical margin around inner ring 14.

Inner ring 14 has an interior cylindrical passage where a hinge pin may be mounted. An interior surface 24 of inner ring 14 has a lubrication groove 26 formed therein. Groove 26 comprises a circumferential groove 26a and a plurality of axial grooves 26b that cross the circumferential groove 26a. There are four grease supply apertures 28 that extend from groove 26a to the spherical surface of inner ring 14. Similar lubrication grooves may be formed on the convex sliding surface of inner ring 14 or on the concave sliding surface of outer ring 12. The pin mounted in inner ring 14 may be equipped with a grease supply aperture therein so that grease can be provided to the bearing 10 via the pin when the hinge is assembled. The grease may thus lubricate the sliding surfaces of the pin and the interior of inner ring 14 as well as the convex and concave sliding surfaces of inner ring 14 and outer ring 12. Inner ring 14 has annual axial end faces 30, 32 that lie in planes that are perpendicular to the central axis of inner ring 14.

To provide a differential between the base materials of outer ring 12 and inner ring 14, inner ring 14 may be made from 440C stainless steel while outer ring 12 is made from a precipitation-hardening martensitic stainless steel. Martensitic stainless steel typically contains chromium (12-14%), molybdenum (0.2-1%), zero to less than 2% nickel, and about 0.1-1% carbon, by weight. It is also known as “series-00” steel. Thus, outer ring 12 may be made from 15-5 ph steel. A 15-5 ph steel may comprises by weight percentage, carbon 0.07%; manganese 1%; phosphorus 0.04%; sulfur 0.03%; silicon 1%; chromium 14.00-15.5%; nickel 3.5-5.5%; copper 2.5-4.5%; and columbium plus tantalum 0.15-0.45%.

When bearing 10 is used in a hinge, the bearing may be inserted into the hinge housing and held therein by the locknut, such that the exterior surface of outer ring 12 engages the hinge housing. The hinge pin, which would be mounted in the interior of inner ring 14, may be made from PH 13-8Mo H1025 or 15-Sph H1025.

In alternative embodiments, outer ring 12 may be made from 17-4 ph steel and inner ring 14 may be made from copper-beryllium alloy. Steel 17-4 ph is a precipitation-hardening martensitic stainless steel that may comprise about 0.07% carbon; 0.6% manganese; 0.7% silicon; 0.03% sulfur; 0.04% phosphorous; 16% chromium; 4% nickel; 2.8% copper, 0.1% molybdenum; and 0.3% niobium. The BeCu greased bearing design option has considerable merit. This is a failsafe design that is ‘triple redundant’. The failsafe features are 1-primary rotation at the ball bore, 2-secondary rotation at the spherical surfaces and 3-inherent failsafe material selection. Life of this bearing design is entirely dependent upon proper re-greasing, maintenance.

For an inner ring 14 having an interior cylindrical passage having a diameter of 63.5 millimeters (mm) (2.5 inch), the width of the end faces (the difference between the outer radius and the inner radius of the annular end face) may be about 5 mm (0.2 inch). However, a greater width, e.g., about 6.35 mm(0.25 inch), would improve the thrust load bearing area and resistance to escape of lubricant.

A second type of spherical plain bearing according to this invention is shown in FIG. 2. Bearing 40 is constructed in generally the same way as bearing 10 of FIG. 1, except for the absence of lubrication grooves. Bearing 40 is a self-lubricating bearing that comprises a lubrication liner between all sliding surfaces. In the illustrated embodiment, bearing 40 has a lubrication liner 42 applied to the interior bore of inner ring 14, the convex spherical sliding surface and at end faces 30 and 32. In a particular embodiment, the inner ring of bearing 40 may comprise 440 hardened CRES steel or titanium (advantageous for weight reduction), while the outer ring may comprise steel 17-4 ph.

FIG. 3 depicts a dropped hinge mechanism for a wing flap that comprises a bearing 10 as described herein. The mechanism 50 allows a flap 52 to pivot away from the fixed wing 54 to adjust the lift of the wing.

The self-lubricated bearing design option is the preferred design for this application. The ball face width of 0.200 inch is sufficient, resulting in a low axial contact stress per typical aircraft hinge assembly criteria. The self-lubricated design is seen to provide all of the necessary failsafe characteristics at a reasonable cost. Weight reduction is also an option for the use of a titanium ball material. With this design, the human factors of reliability and maintainability are eliminated.

A preferred lubricating liner is commercially available under the designation FIBRILOID®, which is described in U.S. Pat. Nos. 3,037,893 and 3,582,166, both of which are hereby incorporated herein by reference is a registered trademark of Roller Bearing Company of America, Inc. A FIBRILOID® material comprises a woven fabric where PTFE fibers are woven with other supporting and bondable fibers. The process used to produce the PTFE fibers results in a fiber which has twenty-five times the tensile strength of the base resin. The weave of the fabric exposes the PTFE fibers on the working surface. The supporting fibers are inter-woven with the PTFE fibers and are predominantly exposed on the surface, which is bonded. This construction provides a positive locking of the PTFE fibers for strength and resistance to cold flow, it also provides a high strength bond to the backing material of the bearing. FIBRILOID® bearings can be incorporated into internal component assemblies inaccessible to conventional lubrication techniques, eliminating costly maintenance tear down. The self-lubricating nature of FIBRILOID® makes it an ideal selection for equipment providing service to remote environments such as oil and gas transmission lines and pumping stations. It also provides function without lubrication while tolerating many lubricating and non-lubricating fluids. FIBRILOID® has a high dynamic load-carrying capacity and inherent dampening qualities. It provides a low coefficient of friction and freedom from stick-slip. In addition, there is an absence of cold-flow tendencies of solid and filled PTFE resins, and it provides high resistance to fatigue under shock loads. The use of FIBRILOID® Eliminates fretting corrosion and FIBRILOID® is resistant to attack by most substances and it functions at temperatures beyond the range of most lubricants. FIBRILOID® provides high wear resistance, good dimensional stability, it is compatible with a wide range of mating materials, it is electrically non-conductive and non-magnetic.

Both of the basic types of bearings described herein, the greased and the self-lubricating, provide a fail-safe design that is ‘triple redundant’: they provide lubrication at the primary rotation site of the pin in bore of the inner ring; they permit secondary rotation at the spherical surfaces between the inner ring and the outer ring, and they provide a failsafe feature in the materials used to make the bearings.

A bearing as described herein may be mounted in a hinge housing, and there may be a sleeve between the housing and the outer surface of the bearing. The sleeve may comprise a BeCu sleeve material per AMS-QQ-C-530.

In a particular application, the bearing is used in situations in which it is desired to prevent rotation of the bearing in the housing. A spanner nut, tab washer, threaded race design is known in the art and is acceptable for anti-rotation of the bearing in the housing and for ease of ‘in-the-field’ repair. A standard ‘spanner wrench’ should be all the tooling that is required in the field. A ‘slip fit’ between the bearing OD and housing ID is recommended (prime and seal with dichromate sealer if desired). An interference fit is not required.

Another common anti-rotation method for this type of bearing incorporates a flange on the bearing race with a bolt/fastener through the bearing flange and housing structure. But this design approach will create stress risers in the Master Beam structure, which may not be desirable in all applications.

The bearings described herein function acceptably under a dynamic load stress level of 50 MPA, which is common for primary flight control systems. The allowable static load levels are higher and depend upon the selected bearing materials. In this ‘flap’ application the stowed flap condition (zero setting) is the minimum dynamic load condition (when the bearing begins to move) and is also the minimum static limit load condition at the same time. The dynamic load level then increases as the air load on the flap increases with increased setting of the flap to 60 degrees (increasing load as a ramp function). Static limit loads may in this application be the sum of the max dynamic load and inertia load due to a hard landing or vertical ‘G’ condition. In particular, the bearings described herein sustain the 50 MPA. Aircraft flight control guidelines for dynamic loading-applied to the thrust faces of the ball.

It should be appreciated that flight control systems incorporating bearings as described herein such as, for example, flight control systems of US military aircraft are designed for a dynamic stress level of 172 MPA with self-lubricated bearings. Only the best performing materials are qualified in these systems. “FIBRILOID®” self-lubricated liner material has been qualified to the SAE specification AS81820. This liner material is qualified at a dynamic load level of 258 MPA, Static Limit load of 551 MPA and Static Ultimate load level of 827 MPA. The FIBRILOID® liner material is qualified with less than ½ of the allowable wear of the performance specification. All stated stress levels are non-Hertzian, simple projected area stresses.

The bearings of this invention function well in heavily contaminated environments, landing gear applications. The materials used for the nonmetallic, self-lubricating bearing liners must be chemically resistant to the various fluids used in and around aircraft. The “FIBRILOID®” liner material is qualified to the fluids encountered in aircraft applications as demonstrated in qualification to the spec AS8 1820. For the BeCu steel (AS8 1936) bearing design option, the metal materials are clearly resistant to the environmental conditions. But, grease will be affected by the fluids and abrasive particles (dirt). Repeated, scheduled re-greasing of a greased bearing is required to flush out the old grease and contamination. This maintenance cycle is required. 500 landing cycles is a common, scheduled frequency for re-greasing, but it will depend upon the location of the bearing application.

The material for the outer pin or housing of a hinge is typically a CRES such as 15-5 ph H1025 is a common (low cost). In an alternative embodiment, an outer pin may comprise PH13-8Mo H1025. This may allow a significant reduction in the diameter of the pin and resulting reduction in the bearing size and weight. PH13-8Mo is not susceptible to stress chloride corrosion (while in tension) and can be aged below 1000° F. This alloy has better corrosion resistance than the other PH CRES alloys and has better fatigue properties. And, the hardness of the material is higher and therefore the bearing wear properties of the material are improved.

The inventors have discovered that a high frequency vibration is the single most destructive operating characteristic that separates the wear performance of bearing materials. Nonmetallic materials against a metal mating surface will significantly out perform any combination of metal on metal mating surfaces. A polymeric, nonmetallic material will absorb and dampen high frequency vibration. Metal on metal surfaces will wear, gall and weld when in a vibration environment. The grease itself is the only material that will protect a metal to metal, greased bearing.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced item.

Although the invention has been described with reference to particular embodiments thereof, it will be understood by one of ordinary skill in the art, upon a reading and understanding of the foregoing disclosure, that numerous variations and alterations to the disclosed embodiments will fall within the spirit and scope of this invention and of the appended claims.

What is claimed is:

1. A spherical plain bearing comprising:
an outer ring member having a spherically concave first bearing surface;
an inner ring member having a spherically convex second bearing surface in sliding disposition to the first bearing surface and a third bearing surface for engaging a pin to be mounted in the bearing;
wherein at least one bearing surface comprises a lubrication groove; and
wherein one of the outer ring member and the inner ring member comprises 440 stainless steel and the other comprises a precipitation-hardened martensitic stainless steel.

2. The bearing of claim 1, wherein the outer ring member comprises a precipitation-hardened martensitic stainless steel.

3. The bearing of claim 2, wherein the outer ring member comprises 15-5 ph steel.

4. A spherical plain bearing comprising:
an outer ring member having a spherically concave first bearing surface;
an inner ring member having a spherically convex second bearing surface in sliding disposition to the first bearing surface and a third bearing surface for engaging a pin to be mounted to the bearing;
wherein at least one bearing surface comprises a lubrication groove; and
wherein one of the outer ring member and the inner ring member comprises steel and the other comprises a copper-beryllium alloy.

5. The bearing of claim 4, wherein the outer ring member comprises a precipitation-hardened martensitic stainless steel.

6. The bearing of claim 2, wherein the outer ring member comprises 17-4 ph steel.

7. A self-lubricating plain spherical bearing comprising:
an outer ring member having a spherically concave first bearing surface;
an inner ring member having a spherically convex second bearing surface in sliding disposition to the first bearing surface and a third bearing surface for engaging a pin to be mounted to the bearing; and
a lubrication liner on the third bearing surface and on one of the first bearing surface and the second bearing surface.

8. The bearing of claim 7, wherein the inner ring member comprises ring faces at the axial ends thereof, and comprising a lubrication liner on the end faces.

9. The bearing of claim 7, wherein the lubrication liner comprises woven PTFE.

10. A dropped hinge mechanism for a flap on a fixed wing aircraft, wherein the mechanism comprises a hinge and the hinge includes a bearing according to claim 1.

11. The mechanism of claim 10 comprising a hinge pin in the bearing, the hinge pin comprising a precipitation-hardened martensitic stainless steel.

12. A dropped hinge mechanism for a flap on a fixed wing aircraft, wherein the mechanism comprises a hinge and the hinge includes a bearing according to claim 4.

13. The mechanism of claim 11 comprising a hinge pin in the bearing, the hinge pin comprising a precipitation-hardened martensitic stainless steel.

14. A dropped hinge mechanism for a flap on a fixed wing aircraft, wherein the mechanism comprises a hinge and the hinge includes a bearing according to claim 7.

15. The mechanism of claim 14 comprising a hinge pin in the bearing, the hinge pin comprising a precipitation-hardened martensitic stainless steel.
